(19) United States
(12) Patent Application Publication
(10) Pub. No.: US 2015/0275331 A1
(43) Pub. Date: Oct. 1, 2015

(54) Recovery of Molybdenum from Spent Petrochemical Catalysts

(71) Applicant: Roberto Nunes Szente, Montreal (CA)

(72) Inventor: Roberto Nunes Szente, Montreal (CA)

(21) Appl. No.: 14/225,651

(22) Filed: Mar. 26, 2014

(51) Int. Cl. C22B 34/34; C22B 4/00; C01F 7/46

(52) U.S. Cl. CPC C22B 34/345; C01F 7/46; C22B 4/005

(57) ABSTRACT

A process to recover molybdenum contained in spent petrochemical catalysts has been invented. The proposed process permits the recovery of molybdenum in the form of an alloy, which can also contain other elements, such as nickel, cobalt, tungsten, iron and others. The process starts with a calcining operation for removal of hydrocarbons initially present in the spent catalysts, as well as to oxidize molybdenum and eventual other metal elements, such as nickel, cobalt, tungsten, iron; the calcined material is then fed into a plasma reactor, where molybdenum is recovered in an alloy formed with the other possible elements; the metal alloy can be readily commercialized. Besides recovering molybdenum, the plasma process also generates inert ceramic byproducts, containing alumina, silica and fluxing agents, such as lime. The process is clean and can be used for continuous operation, treating several types of materials, particularly spent catalysts, containing molybdenum or similar elements.

### BACKGROUND OF THE INVENTION

a) Field of the Invention

The present invention relates to a process to recover the molybdenum contained in spent petrochemical catalysts, used to remove sulfur from diesel, gasoline and other fuels and hydrocarbons in general, all those normally produced in petrochemical installations.

Catalysts containing molybdenum, used in petrochemical processes, are typically alumina substrates, containing molybdenum disulfide, in amounts of 10% in weight, although the amount of molybdenum can vary from 5 to 25% in weight. Molybdenum disulfide is the main catalyst element, but also nickel and/or cobalt and/or tungsten and/or iron can be found in the catalyst, in the form of metals or oxides, in amounts from 0 to 5% in weight.

After the molybdenum catalysts lose or reduce their efficiency for removal of sulfur, due to contamination of compounds present in the hydrocarbons being processes, they are substituted by fresher catalysts. The spent catalysts are discarded or sent to companies that recover partially the molybdenum contained in the catalysts using a chemical route. It is shown below some of the problems arisen from using the chemical route or other possible solutions and how the proposed invention overcomes those difficulties.

b) Brief Description of the Prior Art

Spent petrochemical molybdenum catalysts are discarded or sent to companies that recover partially the molybdenum, with or without the other elements present in the catalysts. Examples of patented processes for the recovery of molybdenum using chemical routes include: U.S. Pat. No. 4,514,369 and U.S. Pat. No. 4,432,949. Both patents deal with processes that utilize acids to promote the leaching of the molybdenum, followed by an extraction of ionic separation of the elements. In general, it can be said that the chemical route is not only inefficient but also produces hazardous and possible polluting streams; due to more restrict environmental legislation, for instance, there is no commercial unit in the United States recovering molybdenum using chemical routes.

An alternative to the chemical route is to use electric arc furnaces for the recovery of valuable elements contained in spent catalysts. This is presented in the patents U.S. Pat. No. 5,03,274 and U.S. Pat. No. 4,337,085, for example, both dealing with the recovery of nickel from spent catalysts. In those two patents, an electric arc is maintained between graphite electrodes, which are immersed into the material being processed. The passage of the electric arc through the material, spent catalysts, heats it up, melting the contained nickel, which is poured out from the electric arc furnace, together with the ceramic molten substrate. Some disadvantages of the electric arc furnace process for the recovery of nickel, which would also be found for the recovery of molybdenum, are: i) difficulty for starting the operation, since the electric arc has to pass through the non conductive material in order to reach the graphite electrodes; ii) consumption of the graphite electrodes by the oxides and other compounds present in the spent catalysts; iii) relatively high instability of the electric arc striking between the electrodes, causing perturbations in the process and in the electrical power lines; iv) restrict operation conditions, due to the necessity of the electric arc to pass through the non conductive ceramic and therefore limiting the amount and composition of the material being processed.

### BRIEF SUMMARY OF THE INVENTION

The objective of the present invention is to provide a process, associated with the proper equipment, for the recovery of molybdenum contained in spent petrochemical catalysts. The recovered molybdenum, in the form of an alloy, can be readily commercialized or can be further processed to generate other products. The proposed process and associated equipment overcome the limitations of the other processes mentioned hereinabove.

More particularly, the object of the invention is to provide a process, associated with the proper equipment, for the recovery of molybdenum, which forms an alloy with nickel and/or cobalt and/or tungsten and/or iron, one or all present initially in the spent catalysts; the obtained alloy, having molybdenum is the main element, can be readily commercialized or further processed, for instance, purified, to generate other products.

The proposed process is based on plasma technology, and has the following advantages as compared to other processes:

a) when not utilizing a chemical route, the process does not generate hazardous or polluting streams;

b) when not utilizing a chemical route, the process has a very high molybdenum recovery efficiency;

c) when not utilizing an electric arc furnace, the process increases the flexibility of the operating conditions, increasing the stability of the process, increasing also the recovery efficiency of molybdenum and avoiding the consumption of the working graphite electrodes by the oxides present in the spent catalysts;

d) a simpler piece of equipment is needed for obtaining the desired recovery of the molybdenum, when compared to electric arc furnaces, resulting in substantial capital and operating costs.

### DETAILED DESCRIPTION OF THE INVENTION

In accordance with a preferred non restrictive embodiment of the invention, the proposed process comprises the following operations: i) handling and feeding the spent molybdenum catalysts into a rotary furnace, for instance, a kiln, operated between 300 and 1,200° C., the temperature maintained using one or more gas/oil burners; the kiln works as a calciner, air being admitted into the kiln for providing the necessary oxygen for the oxidation of the different compounds. In this process step, all the hydrocarbon compounds present initially in the spent catalysts will be oxidized and removed; the molybdenum disulfide will be oxidized, resulting in molybdenum oxide, as well as nickel and/or cobalt and/or tungsten and/or iron, that will all be oxidized to their respective oxides; also most or all the sulfur initially present will be removed from the spent catalysts, in the form of sulfur oxides; the calcining operation although not a mandatory step of the overall process, contributes to the next step of the process, the plasma operation, particularly since the presence of sulfur in the spent catalysts could attack the refractory lining of the plasma reactor; ii) feeding the calcined spent catalysts into a plasma reactor, where a transferred plasma torch maintains the internal temperature of the reactor between 1,500 and 2,500° C. The pressure inside the plasma reactor is maintained close to atmospheric pressure and nitrogen or similar gases are used as the plasma gas. The electric arc provided by the transferred plasma torch strikes between the electrode of the torch, located above the material being processed, passing through the material, reaching an electrode located preferentially at the bottom of the reactor, in a typical transferred plasma torch operation. At those operating temperatures, and adding reducing agents, such as carbon, promote the reduction of the molybdenum oxide, as well as nickel oxide and/or cobalt oxide and/or tungsten oxide and/or iron oxide, into their respective metal form. Due to the presence of the different metal elements, the formed alloy has a melting temperature below the operating temperature of the plasma reactor and therefore, the alloy is melted inside the reactor; fluxing agents, such as lime, are also added to the charge, in order to decrease the viscosity of the ceramic compounds, particularly of the alumina substrate, which facilitates the migration of the liquid metal alloy, due to its higher density than the ceramic compounds, towards the bottom of the plasma reactor; iii) tapping periodically the metal alloy, containing molybdenum primarily, but having also one or all of the following metals: nickel, cobalt, tungsten, iron, generating solid metal alloy ingots; tapping periodically, preferentially from a different tapping hole, the ceramic compounds, generating solid ceramic matrix compounds. Due to their differences in density, surface tension, composition, the two material, metal alloy and ceramic matrix, are easily separated if during the tapping operation one of those two materials comes out with the other; iv) commercializing the obtained molybdenum alloy as the main product of the process and possibly the ceramic matrix as a byproduct; v) common metallurgical purification methods, such as for the removal of eventual phosphorus present in the obtained metal alloy, can be performed for generating purer or different products. The metal alloy can, in principle, be used directly in metallurgical applications and the ceramic matrix, as aiding compound for also metallurgical processes, such as for the removal of sulfur from steel. The presence of nickel and/or cobalt and/or tungsten and/or iron oxides initially in the calcined spent catalysts allows the use of carbon for the reduction of the molybdenum oxide in the plasma reactor; carbon in principle cannot reduce directly molybdenum oxide at the operating conditions of the plasma reactor; however, carbon can reduce, at the operating conditions of the plasma reactor, the other oxides, nickel and/or cobalt and/or tungsten and/or iron; the resulting metals will then act as a reducing agent to the molybdenum oxide, resulting in the overall operation, in the desired molybdenum recovery; molybdenum forming therefore an alloy with the other metal elements nickel and/or cobalt and/or tungsten and/or iron or other metals present in the process. When there is no other element present in the catalysts, except of molybdenum oxide and the alumina-silica substrate, nickel or silicon or aluminum can be used as reducing agents for the molybdenum oxide.

The invented process is a much simpler and efficient method of recovery of molybdenum from spent petrochemical catalysts than the methods proposed by other researchers, besides generating higher value products; the equipment to conduct the process is exemplified below.

The process accordingly to the invention is conducted preferentially and non restrictively in a series of equipment as follows: i) a rotary kiln, operating between 300 and 1,200° C., those temperatures maintained using one or more oil/gas burners; the kiln has an internal refractory lining and appropriate feeding and removal ports for the material being treated; ii) a plasma reactor, operating at temperatures between 1,500 and 2,500° C., having a transferred plasma torch, internal refractory lining, tapping holes, a secondary anode for the operation of the plasma torch, appropriate feeding ports and appropriate off gases ports; iii) a conventional gas cleaning system for treating the off gases coming from the calciner and from the plasma reactor, before releasing the gases to the atmosphere; iv) several secondary pieces of equipment, such as conveyor belts, feeding screws, discharge vessels and others, typical of metallurgical and calciner operations.

Of course numerous modifications could be made to the preferred process and embodiment of the invention disclosed hereinabove, without departing from the scope of the present invention as defined in the claims. Thus, for instance, it has been disclosed hereinabove that there is a transferred plasma torch located at the top of the reactor; this is just one possible arrangement, another arrangement being that instead of a plasma torch, a graphite electrode be used, working similarly to a transferred plasma torch.

I claim:

1. A process for recovering molybdenum initially present in spent petrochemical catalysts; the molybdenum is recovered in an alloy, having possibly one or several other elements, such as nickel, cobalt, tungsten, iron or others; a ceramic compound, made mainly of the alumina substrate of the catalysts, containing fluxing agents, such as lime, is also generated in the process as a byproduct. Both molybdenum alloy and ceramic compound can be readily commercialized or be further processed in order to generate purer or different products. The process comprises:
continuous feeding of molybdenum spent catalysts in a rotary kiln;
operating temperature of the kiln between 300 and 1,200° C.;
oxidizing conditions inside the kiln are maintained;
removal of the initially contained hydrocarbon compounds and transformation of the molybdenum disulfide into molybdenum oxide;
oxidation of possibly other elements initially present in the spent catalysts, such as nickel, cobalt, tungsten, iron;
continuous removal from the kiln of the calcined material;
continuous feeding of the calcined material into a plasma reactor;
operating temperatures of the plasma reactor between 1,500 and 2,500° C., using a transferred plasma torch to provide the energy for the process;
non oxidizing conditions inside the plasma reactor;
addition of reducing agents, such as carbon, for the transformation of the molybdenum oxide into molybdenum metal, as well as the transformation of other possible oxides, including nickel, cobalt, tungsten, iron, into their respective metal forms;
addition of a fluxing agent, such as lime, to decrease the viscosity of the ceramic compound, made initially of alumina and possibly silica;
generation of a metal alloy made of molybdenum and possibly nickel, cobalt, tungsten, iron, all melted inside the plasma reactor;
periodically tapping of the metal alloy;
periodically tapping of the ceramic compound;
production of a metal alloy and of a ceramic compound, both suitable for commercialization;
possibly further purification of the metal alloy for generating other products;
cleaning the off gases coming from the kiln and the plasma reactor before they are released to the atmosphere.

2. The process of claim 1, wherein the material is fed in a batch manner into the kiln reactor;

3. The process of claim 1, wherein the material is fed in a batch manner into the plasma reactor;

4. The process of claim 1, wherein there is no calcining process;

5. The process of claim 1, wherein there is an addition of reagents into the kiln;

6. The process of claim 1, wherein the reducing agent added to the charge in the plasma reactor be silicon, aluminum nickel or other reducing agent;

7. The process of claim 1, wherein the plasma torch is substituted by one or more graphite electrodes;

8. The process of claim 1, wherein the plasma torch is of a non transferred type;

9. The process of claim 1, wherein there is an addition in the plasma reactor of other fluxing agents than lime;

10. The process of claim 1, wherein there is no addition of fluxing agents in the plasma reactor.
